(19) United States
(12) Patent Application Publication
(10) Pub. No.: US 2021/0206891 A1
(43) Pub. Date: Jul. 8, 2021

(54) TUBE AND METHOD FOR MAKING SAME

(71) Applicant: SAINT-GOBAIN PERFORMANCE PLASTICS CORPORATION, Solon, OH (US)

(72) Inventors: John J. HEINDEL, Bordentown, NJ (US); Katie CAMPBELL, Northborough, MA (US)

(21) Appl. No.: 17/136,313

(22) Filed: Dec. 29, 2020

Related U.S. Application Data
(60) Provisional application No. 62/955,507, filed on Dec. 31, 2019.

(51) Int. Cl. C08F 14/22; C08F 14/26; C08F 14/28

(52) U.S. Cl. CPC C08F 14/22; C08F 14/28; C08F 14/26

(57) ABSTRACT

A tube includes a layer including a fluoropolymer has a crystallite size of less than about nanometers per crystalline particle and a refractive index of less than 1.40.

### CROSS-REFERENCE TO RELATED APPLICATION(S)

This application claims priority under 35 U.S.C. § 119(e) to U.S. Provisional Patent Application No. 62/955,507, entitled “TUBE AND METHOD FOR MAKING SAME,” by John J. HEINDEL and Katie CAMPBELL, filed Dec. 31, 2019, which is assigned to the current assignee hereof and incorporated herein by reference in its entirety.

### FIELD OF THE DISCLOSURE

This application in general, relates to a tube and a method for making same, and in particular, relates to a conduit for a liquid fragrance.

### BACKGROUND

In many industries, product marketing can be a challenging and complex process, and despite the underlying virtues of a product, marketing approaches continue to play a significant role in product success and ultimately the success of the vendor. Particularly, in modish industries, such as fashion apparel, fashion accessories, cosmetics, fragrances and other personal beauty products, the marketability of a product is determined in a large part by aesthetically pleasing product packaging and presentation. As such, the ability to develop and present a product in a unique and desirable manner is of the highest priority for vendors of modish products.

In the context of personal beauty products, a consumer may be more likely to purchase a product packaged in an aesthetically pleasing manner. Consequently, manufactures have developed techniques to conceal or obscure non-decorative and functional packaging components. Such techniques include the use of creative designs and colors on the exterior of containers. Other manufacturers have provided such decorations on both interior and exterior packaging parts to conceal components of the packaging or of the product itself. In the particular context of fragrance products, dispensing mechanisms represent a notable aesthetic challenge.

Accordingly, in view of the foregoing, there is a continuous need in the industry for improvements in product packaging. Moreover, manufacturers continue to demand new and unique techniques related to product design and packaging in order to gain a competitive edge.

### SUMMARY

In an embodiment, a tube includes a layer including a fluoropolymer having a crystallite size of less than about 380 nanometers per crystalline particle and a refractive index of less than 1.40.

In another embodiment, a method of forming a tube includes: providing a fluoropolymer; extruding the fluoropolymer at a temperature of greater than 550° F.; and quenching the extruded fluoropolymer at a temperature of less than 80° F.

In a particular embodiment, a tube includes: a layer including a terpolymer of tetrafluoroethylene, hexafluoropropylene, and vinylidene difluoride, wherein the terpolymer has a crystallite size of less than about 380 nanometers per crystalline particle.

In another embodiment, a fragrance product includes a container containing liquid fragrance; and a dispenser assembly for dispensing the liquid fragrance including: a transport assembly; and a tube connected to the transport assembly and extending into the liquid fragrance, wherein the tube comprises a terpolymer of tetrafluoroethylene, hexafluoropropylene, and vinylidene difluoride, wherein the terpolymer has a crystallite size of less than about 380 nanometers per crystalline particle.

### BRIEF DESCRIPTION OF THE DRAWINGS

The present disclosure may be better understood, and its numerous features and advantages made apparent to those skilled in the art by referencing the accompanying drawings.

FIG. 1 is an illustration of a system including a tube immersed in and containing a liquid fragrance, the liquid fragrance product and tube having an index of refraction difference of 0.10.

FIG. 2 is an illustration of a system including a tube immersed in and containing a fluid, the fragrance product and tube having an index of refraction difference of 0.02.

FIG. 3 is an illustration of a system including a tube immersed in and containing a fluid, the fragrance product and tube having an index of refraction difference of 0.00.

FIG. 4 is an illustration of a system including a tube immersed in and containing a fluid, the fragrance product and tube having an index of refraction difference of 0.02.

FIG. 5 is an illustration of a fragrance product including a container and dispenser assembly according to one embodiment.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having” or any other variation thereof, are open-ended terms and should be interpreted to mean “including, but not limited to . . . .” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C.+/−5° C. per ASTM, unless indicated otherwise.

According to one embodiment, a tube includes a layer including a fluoropolymer. The fluoropolymer has a crystallite size of less than about 380 nanometers per crystalline particle. In an embodiment, the fluoropolymer has a refractive index of less than 1.40. In a particular embodiment, a fragrance product includes a container containing a liquid fragrance and a dispenser assembly for dispensing the liquid fragrance, wherein the dispenser assembly includes a transport assembly and the tube. The tube extends into the liquid fragrance and is connected to the transport assembly. According to this embodiment, the tube and the liquid fragrance each have a refractive index and the difference (absolute value) between the refractive index of the tube and the liquid fragrance is not greater than about 0.04.

Referring to the tube, the tube provides a reservoir for transporting the liquid fragrance product from the container, through the transport assembly, to the consumer. The tube extends into the liquid fragrance and by capillary action the liquid fragrance fills the tube to a particular level. According to one embodiment, the tube can be comprised of a fluoropolymer. An exemplary fluoropolymer may be formed of a homopolymer, copolymer, terpolymer, or polymer blend formed from a monomer, such as tetrafluoroethylene, hexafluoropropylene, chlorotrifluoroethylene, trifluoroethylene, vinylidene fluoride, vinylidene difluoride, vinyl fluoride, perfluoropropyl vinyl ether, perfluoromethyl vinyl ether, or any combination thereof.

In an embodiment, the fluoropolymer includes a terpolymer of tetrafluoroethylene, hexafluoropropylene, and vinylidene difluoride. Typically, the fluoropolymer includes any nominal fluorine content envisioned. In an embodiment, the nominal fluorine content is greater than about 60 weight %, such as about 60 weight % to about 80 weight %, or even about 60 weight % to about 70 weight %. It will be appreciated that the nominal fluorine content can be within a range between any of the minimum and maximum values noted above.

In a further embodiment, the layer of the tube may include any additive envisioned. For instance, the fluoropolymer may include any additive including, for example, a curing agent, an antioxidant, a filler, an ultraviolet (UV) agent, a dye, a pigment, an anti-aging agent, a plasticizer, the like, or combination thereof. In an embodiment, the curing agent is a crosslinking agent provided to increase and/or enhance crosslinking of the fluoropolymer of the layer. In a further embodiment, the use of a curing agent may provide desirable properties such as decreased permeation of small molecules and improved elastic recovery of the layer compared to a layer that does not include a curing agent. Any curing agent is envisioned such as, for example, a dihydroxy compound, a diamine compound, an organic peroxide, or combination thereof. An exemplary dihydroxy compound includes a bisphenol AF. An exemplary diamine compound includes hexamethylene diamine carbamate. In an embodiment, the curing agent is an organic peroxide. Any amount of curing agent is envisioned. Alternatively, the layer including the fluoropolymer may be substantially free of crosslinking agents, curing agents, photoinitiators, fillers, plasticizers, or a combination thereof. “Substantially free” as used herein refers to less than about 1.0% by weight, or even less than about 0.1% by weight of the total weight of the fluoropolymer of the layer.

In a particular embodiment, the layer includes at least 70% by weight of the fluoropolymer layer. For example, the layer may include at least 85% by weight fluoropolymer layer, such as at least 90% by weight, at least 95% by weight, or even 100% by weight of the fluoropolymer layer. In an example, the layer may consist essentially of the fluoropolymer layer. In a particular example, the layer may consist essentially of the terpolymer of tetrafluoroethylene, hexafluoropropylene, and vinylidene difluoride. As used herein, the phrase “consists essentially of” used in connection with the fluoropolymer of the layer precludes the presence of non-fluorinated polymers and fluorinated monomers that affect the basic and novel characteristics of the fluoropolymer, although, commonly used processing agents and additives such as antioxidants, fillers, UV agents, dyes, pigments, anti-aging agents, and any combination thereof may be used in the fluoropolymer.

In further reference to the tube, according to one embodiment, the fluoropolymer of the tube is made from a material having an index of refraction less than about 1.50. According to another embodiment, the tube can have an index of refraction less than about 1.45, less than about 1.43, less than about 1.40, or even less than about 1.38.

In further reference to the tube, a fluoropolymer having a suitable transparency facilitates a desirable, low visibility optical effect of the tube when immersed in and containing a liquid fragrance. In particular, the fluoropolymer has an advantageous crystallite size, such that the clarity of the tube is improved. “A crystallite” as used herein refers to a crystalline (or crystal) particle formed. For instance, the fluoropolymer has crystallite size that is smaller than the wavelength of visible light. In a particular embodiment, the fluoropolymer has a crystallite size of less than about 380 nanometers, such as less than about 250 nanometers, such as less than about 150, such as less than about 100 nanometers, or even less than about 50 nanometers per crystalline particle. In an example, the crystallite size is measured by X-Ray Diffraction (XRD). According to one embodiment, the tube is made of a fluoropolymer having a transparency not less than about 80%, based on percent transmission of a light having a wavelength of 500 microns passing through a 3 mm thick sample. In other embodiments, the tube is made of fluoropolymer having a transparency greater than about 80%, such as greater than about, 85%, such as greater than about 90, or even greater than about 95%.

According to one embodiment, the tube is hollow, thin-walled and has a fine geometry, having an ID (inside diameter) within a range of about 0.1 mm to about 3.0 mm, such as 0.1 mm to about 2.0 mm, or 0.1 mm to about 1.0 mm. A particular sample had an ID of 0.95 mm. OD (outside diameter) is generally within a range of about 0.25 mm to 10.0 mm, such as 0.5 mm to 5.0 mm, or 0.5 mm to 3.0 mm. A particular OD is 1.65 mm. Generally, the tube has a uniform wall thickness, within a range of about 0.05 mm to about 3.0 mm, such as 0.1 mm to 1.0 mm, and most often within a range of about of 0.1 mm to 0.7 5 mm. A particular wall thickness is 0.35 mm to 0.38 mm. It will be appreciated that the ID, OD, and wall thickness can be within a range between any of the minimum and maximum values noted above.

In regards to the tube, formation of the tube from a fluoropolymer having a suitable crystallite particle size facilitates the low visibility optical effect of the tube immersed in and containing the liquid fragrance. Furthermore and in an embodiment, the fluoropolymer has a desirable degree of crystallinity. According to one embodiment, the crystallinity of the material of the tube is greater than about 50%, such as greater than about 55%, such as greater than about 60%, or even greater than about 65%. Typically, crystallinity is about 50% to about 85%, such as about 60% to about 80%, or even about 65% to about 80%. Indeed, certain embodiments are found to have a crystallinity of about 65% to about 80%, such as about 65% to about 70%, or even about 70% to about 80%. In an embodiment, the crystallinity is about 50% to about 70%, such as about 50% to about 60%. It is contemplated that even with a high degree of crystallinity, the advantageous crystallite particle size provides desirable clarity. Noteworthy, the above crystallinity values are measured based on X-Ray Diffraction (XRD). It is noted that other crystallinity measurement techniques such as Differential Scanning calorimetry (DSC) may provide different crystallinity data; however, crystalline contents specified herein are quantified by XRD. Any reasonable XRD characterization parameters are envisioned. In an embodiment, XRD characterization parameters are as follows: Voltage: 45 kV, Current:40 mA, XRD Machine: Bruker D8 Discover w/Gadds Detector, 0.3 mm slit, 0.3 mm collimation, Cu Radiation, Goebel Mirror (parallel beams), 0.5 mm oscillation along tube length, 5 frames (˜15°/frame), 72 seconds/frame, Omega=7°, midpoint for detection frames=14°, 29°, 44°, 59°, 74°. It will be appreciated that the crystallinity can be within a range between any of the minimum and maximum values noted above.

In a particular embodiment, the fluoropolymer layer may be provided by any method envisioned and is dependent upon the fluoropolymer material chosen. In an embodiment, the fluoropolymer material is melt processable. “Melt processable” as used herein refers to a fluoropolymer material that can melt and flow to extrude in any reasonable form such as films, tubes, fibers, molded articles, or sheets. For instance, the melt processable fluoropolymer material is a flexible material. In an embodiment, the fluoropolymer material is extruded, injection molded, or mandrel wrapped. In an exemplary embodiment, the fluoropolymer material is extruded. The layer may be cured in place using a variety of curing techniques such as via heat, radiation, or any combination thereof.

According to a particular feature, embodiments may be produced utilizing a high temperature melt extrusion process in combination with a quenching sequence that facilitates creation of high transparency, high clarity, and/or low crystallite particle size for the tube, which may take on particular significance in the context of fine dimension, thin-walled tubes as described above. For instance, the fluoropolymer may be extruded at a temperature of greater than 550° F.; and quenching the extruded fluoropolymer at a temperature of less than 80° F. In an embodiment, the extrusion temperature is about 550° F. to about 660° F., such as about 550° F. to about 650° F., such as about 560° F. to about 620° F., such as about 575° F. to about 620° F., or even about 580° F. to about 615° F. In an embodiment, the extrusion temperature is about 600° F. to about 660° F., such as about 600° F. to about 650° F., or even about 610° F. to about 650° F. In an embodiment, the extruded fluoropolymer is quenched at a temperature of less than about 80° F., such as less than about 75° F., such as less than about 70° F., or even less than about 65° F. In an embodiment, the extruded fluoropolymer is quenched at a temperature of about 60° F. to about 80° F. It will be appreciated that the temperatures can be within a range between any of the minimum and maximum values noted above. Although not to be bound by theory, it is postulated that high temperature extrusion in combination with quenching provides a fluoropolymer tube with high transparency and/or smaller crystallite particle size. It is contemplated that fine dimensional tubes may assist in achieving a generally uniform temperature profile through the thickness of the tube, further enhancing transparency and/or forming smaller crystallite sizes. In a particular embodiment, the tube is a single layer of the fluoropolymer material.

In an embodiment, any post-cure steps may be envisioned. In particular, the post-cure step includes any thermal treatment, radiation treatment, or combination thereof. Any thermal conditions are envisioned. In an embodiment, the post-cure step includes any radiation treatment such as, for example, e-beam treatment, gamma treatment, or combination thereof. In an example, the gamma radiation or ebeam radiation is at about 0.1 MRad to about 80 MRad. In a particular embodiment, the post-cure step may be provided to eliminate any residual volatiles, increase crosslinking, or combination thereof.

According to one embodiment, a fragrance product includes a container containing a liquid fragrance and a dispenser assembly for dispensing the liquid fragrance, wherein the dispenser assembly includes a transport assembly and the tube. In an embodiment, the container is substantially transparent. A variety of degrees of transparency are suitable, as it will be appreciated that the transparency of the container is a function of packaging and customer appeal. While opaque fragrance product containers have been utilized in the industry, typically the present container is at least translucent or, more typically, substantially transparent. Use of substantially transparent containers herein may facilitate the viewing of the liquid fragrance and provide a sense of clarity and assurance to the consumer in the purchased product. Most often, the substantially transparent container has a tint or color, generally a tint or color that is not native to the material of the container, which is generally a glass such as a silica-based glass.

Referring to the liquid fragrance within the container, as used herein, the term “fragrance” is used to define a substance that is applied to a person and which diffuses an aroma for its aesthetic and/or functional qualities. According to an embodiment, the liquid fragrance includes at least one of a base note, middle note, and a top note. The term “note” can refer to a single scent of a perfume or it can refer to the degree of volatility of certain fragrant compounds. Accordingly, compositions categorized as top notes have the highest degree of volatility and therefore the fragrance is brief. Depending upon the manufacturer, a fragrant compound of the top note variety typically lasts only a few minutes and is described as an assertive or sharp scent. Compositions categorized as middle notes (also referred to as heart notes) have a moderate volatility and emerge after the top note evaporates. A middle note, appears anywhere from about 10 minutes to an hour after the initial application. A base note composition has the most long lasting fragrance and is a rich or deep scent, generally appearing about 30 minutes to an hour after the initial application. According to one embodiment, the fragrance contains compositions of more than one note, which is referred to as an accord or a combination of scents that derive a different and distinct scent. In another embodiment, the fragrance contains a mixture of all three notes.

According to another embodiment, the liquid fragrance is categorized as a perfume extract, perfume, eau de toilette, eau de cologne, or aftershave. The distinction between these categorizations of personal fragrance compositions indicates the percentage of aromatic compounds present in the fragrance. As used herein, a perfume extract contains about 20-40% aromatic compounds while an eau de parfum contains about 10-20% aromatic compounds. An eau de toilette contains about 5-10% aromatic compounds and an eau de cologne contains about 2-3% aromatic compounds, while an aftershave contains about 1-3% aromatic compounds. It is noted that while these values may differ among manufacturers, however the hierarchy of the categorization is consistent among manufacturers. Regardless of the differences in percentages between manufacturers, the present liquid fragrance is suitable as any fragrance composition independent of the distinct percentage of aromatic compounds present. Embodiments of the present disclosure are particularly directed to perfume extracts, eau de parfum, and eau de toilettes, and even more particularly perfume extracts and eau de parfum.

In further reference to the liquid fragrance, according to another embodiment, the liquid fragrance generally includes a carrier compound. As indicated by the name, a carrier compound serves to dilute and carry the aromatic compound and a suitable carrier compound includes either an oil or alcohol. As such, suitable carrier oils include naturally-occurring compounds such as those oils from nuts and seeds. For example, common carrier oils are extracted from soybean, sweet almond, aloe, apricot, grape seed, calendula, olive oil, jojoba, peach kernel and combinations thereof. The carrier compounds may also use an alcohol-based compound, including for example, ethanol, isopropyl, phenol, glycerol or a group of alcohols more commonly referred to as fatty alcohols and combinations thereof.

According to another embodiment, the liquid fragrance also includes an aromatic compound. In one embodiment the aromatic compound is a naturally occurring organic compound, such as an essential oil or a combination of essential oils. Generally, essential oils are a broad class of volatile oils, extracted from plants, fruits, or flowers having a characteristic odor. Generally, the essential oils derive their characteristic odor from one of two basic organic building blocks present within the composition, those being an isoprene unit or a benzene ring. Yet, the aromatic compounds may come from another class of naturally occurring organic compounds, such as an animal-based extract. Alternatively, the aromatic compounds may be synthetically formed to imitate the smell or even reproduce the chemical constituents, and therefore the characteristic odor of the naturally occurring organic compounds. According to another embodiment, the aromatic compound may be synthetically formed to produce a unique smell that is not reproduced by a naturally occurring organic compound.

Independent of the nature of the compound, be it natural or synthetic, the aromatic compounds derive distinct scents from an aromatic functional group. Typically, the aromatic functional groups are formed by a chemical combination of the isoprene unit or benzene ring building blocks discussed above. As such, suitable aromatic functional groups include alcohols, ethers, aldehydes, keytones, esters, lactones, castor oil products, nitrites, terpenes, paraffins, and heterocycles, or combinations thereof. Generally, one aromatic functional group produces one aroma, however a liquid fragrance, can contain a mixture of aromatic compounds and aromas, as discussed previously in conjunction with the base, middle and top notes. Accordingly a liquid fragrance product can contain one or more aromatic compounds with one or more aromatic functional groups.

The liquid fragrance product may further include a fixative, such as a material for binding various aromatic compounds and making the fragrance last for longer durations. A suitable fixative can include naturally occurring materials such as balsams, angelica, calamus, orris, or alternatively an animal-based extract such as ambergris, civet, castoreum or musk. Alternatively, fixatives can be synthesized materials containing derivatives of or equivalents to naturally occurring materials or other materials such as phthalates or glycerin.

Generally, the liquid fragrance has an index of refraction less than about 1.50 such as within a range of between about 1.32 and 1.45. In one embodiment, the liquid fragrance has an index of refraction within a range of between about 1.35 and 1.42, such as in a range of between about 1.36 and 1.40. Still other embodiments have a liquid fragrance with an index of refraction within a range of between about 1.37 and 1.39.

Referring to the dispenser assembly, the dispenser assembly generally includes a mechanism for dispensing the liquid fragrance, for instance, a transport assembly. According to one embodiment, the transport assembly includes a pump for transferring the liquid fragrance product from the interior of the container to the exterior, for application to a person. Generally, the pump uses a pressure differential activated by a variety of mechanisms, such as a button, trigger or bulb actuated by the consumer. According to another embodiment, the transport assembly includes a pneumatic assembly. In a particular embodiment, the liquid fragrance is a perfume and the transport mechanism is a pneumatic assembly to enable perfume delivery in a mist to the consumer in order to effectively disperse the scent, such as over a broad area of the body, thereby providing a larger area of evaporation for the perfume. Accordingly, in one embodiment, the transport assembly includes a sprayer or atomizer, for delivery of the liquid fragrance in a mist.

According to a particular feature, the difference in refractive indices between the tube and the liquid fragrance is not greater than about 0.040, such as not greater than about 0.035 when the tube is immersed in and contains the liquid fragrance. As used herein, the term “delta” or “difference” in refractive indices is the absolute value of the refractive index of the liquid fragrance subtracted from the refractive index of the fluoropolymer material of the tube. In certain embodiments, the delta of such systems having a tube immersed in and containing the liquid fragrance is not greater than about 0.030, such as not greater than about 0.027 or 0.025. In some embodiments, the refractive index delta may be less, such as not greater than about 0.020, or 0.010. Indeed, the refractive indices may be the same (zero delta).

The refractive features according to embodiments herein are of particular significance. The state of the art has developed container assemblies for storage, transport, and dispensing of fluids having structured components that have an index of refraction approximately that of the fluid. For example, U.S. Pat. No. 6,276,566 describes a technique to mount a three-dimensional design within a container to obscure the functional components of the dispensing container. The disclosed delivery tube and liquid product (typically liquid soaps, shampoos, lotions, oils and beverages), have indices of refraction within about 0.50 of each other, preferably within about 0.25 of each other. While in perhaps some applications, an index of refraction spread of that order of magnitude can achieve low visibility (concealment) delivery tubes, it has been discovered that particularly in the context of liquid fragrance products, desired concealment or low visibility of structured components requires more closely matched indices of refraction. Further details are provided below in connection with the drawings.

In addition, attention is drawn to the use of fluoropolymers as described above. It has been discovered that certain fluoropolymers, such as the terpolymer of tetrafluoroethylene, hexafluoropropylene, and vinylidene difluoride is particularly useful in carrying out embodiments of the present invention. In this respect, such fluoropolymers have generally not been utilized in fragrance products, believed to be due in large part to crystalline content which is particularly undesirable in obtaining target tube transparency levels. In contrast, embodiments herein utilize controlled crystalline content and crystallite size materials, and materials having transparency values as described above. Still further, embodiments herein that take advantage of certain fluoropolymers desirably have an index of refraction as noted above (most often not greater than 1.45, 1.43, 1.40, or even not greater than about 1.38), which is particularly notable. That is, common polymers as utilized in the prior art generally have an index of refraction within a range of about 1.4668 to about 1.5894. Such polymers generally cannot meet the concealment requirements in the context of fragrance products.

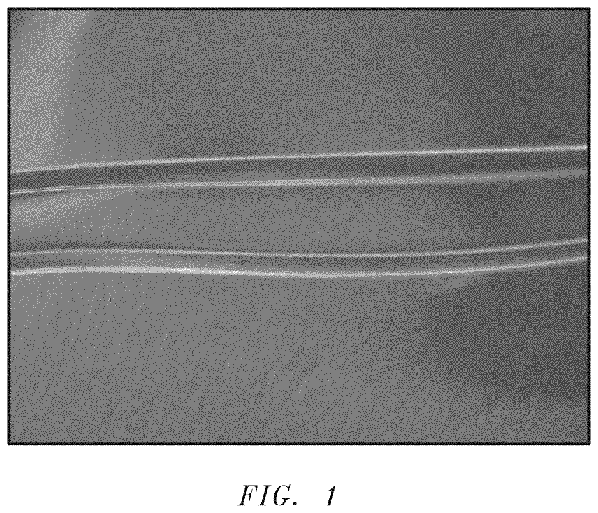

The low visibility optical effect of the tube immersed in and containing a fluid is illustrated in the accompanying Figures. FIG. 1 is an illustration of a tube immersed in and containing a liquid fragrance, wherein the difference between the refractive index of the tube and the liquid fragrance is about 0.10. Here the liquid fragrance is a perfume having an index of refraction of 1.37, while the tube has an index of refraction of 1.47. The tube is formed of polymethylpentene (PMP). As illustrated in FIG. 1 the features of the tube, namely the edges of inner wall and the outer wall, are distinctly visible within the fluid.

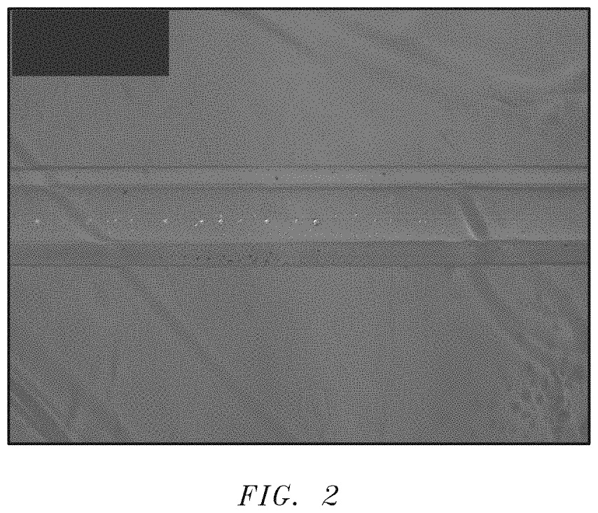

Referring to FIG. 2, a system having a tube immersed in and containing a fluid is illustrated. The delta of the system is approximately 0.02. The low visibility optical effect of the tube within the system is illustrated by a comparison between the systems of FIG. 1 and FIG. 2. As demonstrated in FIG. 1, the features of the tube, such as the inner wall and outer wall, are distinctly visible, however, these same features as illustrated in FIG. 2 are not distinct and less visible. The reduction of the delta from 0.10 in FIG. 1 to 0.02 in FIG. 2, substantially reduces the visibility of the features of the tube to provide a low visibility optical effect.

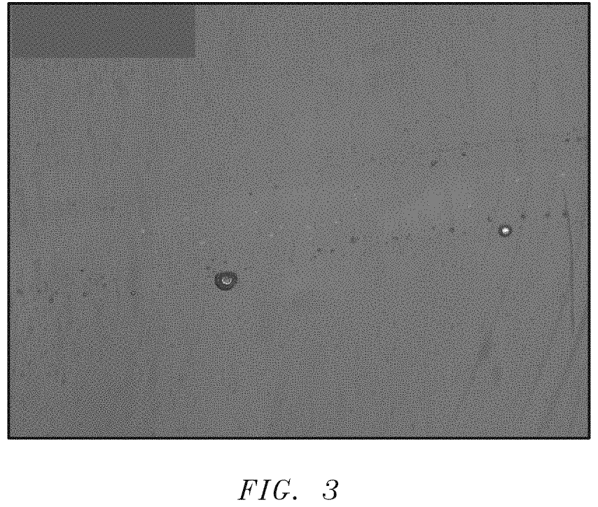

FIG. 3 illustrates a system in which a tube is both immersed in and contains a fluid in which the delta is approximately 0.00 (zero). The low visibility optical effect of the system having a low delta is demonstrated by a comparison between the system of FIG. 1 and the system of FIG. 3. As demonstrated in FIG. 1, the features of the tube, such as the inner and outer edges of the wall that are distinctly visible in FIG. 1 are noticeably less visible in FIG. 3, such that the tube has a low visibility optical effect and is substantially invisible within the system.

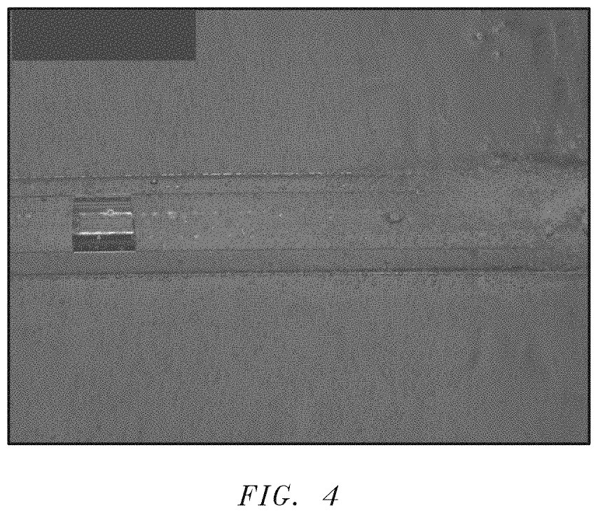

FIG. 4 illustrates a system in which a tube is both immersed in and contains a fluid in which the delta is approximately 0.02. Here, unlike the embodiments described above in connection with FIGS. 1 and 2, the refractive index of the liquid is greater than the tube. The low visibility optical effect of the system having a delta of 0.02 is demonstrated by a comparison of FIG. 4 to both FIGS. 1 and 2. As illustrated in FIG. 1, the features of the tube, such as the inner and outer edges of the wall are distinctly visible, however such features are noticeably less visible in FIG. 4 such that the tube has a low visibility optical effect. In a comparison of the systems of FIG. 4 and FIG. 2, the visibility of the tubes in either of the systems is roughly equivalent. The comparison of the low visibility optical effect is enhanced by the presence of an air pocket within a portion of the tube illustrated in FIG. 4. The presence of the air pocket within a portion of the tube demonstrates a portion of the system in which the delta is notably greater than 0.02. The inner wall and outer wall of the tube in the portion containing the air pocket is more visible than the portions of the tube containing the liquid. This comparison further illustrates the low visibility optical effect of providing a delta of about 0.02.

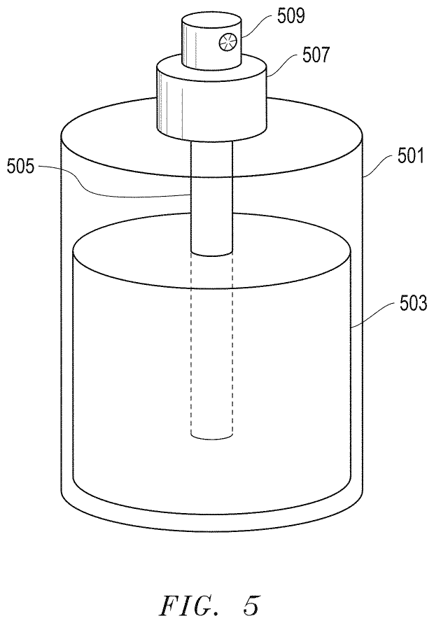

FIG. 5 illustrates an embodiment of a fragrance product including a container 501 housing a liquid fragrance 503, and further including a dispenser assembly having a transport assembly composed of cap structure 507 and pump member 509. Downward depression of pump member causes dispensing of the liquid fragrance, most often in an atomized fashion. The dispenser assembly further includes tube 505 that essentially disappears as it extends into the liquid fragrance 503, and functions to feed the transport assembly with continued supply of liquid fragrance until most of the liquid fragrance is used. In practice, embodiments have demonstrated a remarkable ability to achieve an almost completely disappearing tube as it extends into the liquid fragrance. When full, the fragrance product appears entirely ‘tubeless,’ the tube being virtually indiscernible upon casual inspection.

Although generally described as a tube, any reasonable polymeric article can be envisioned. The polymeric article may alternatively take the form of a film, a washer, or a fluid conduit. For example, the polymeric article may take the form or a film, such as a laminate, or a planar article, such as a septa or a washer. In another example, the polymeric article may take the form of a fluid conduit, such as tubing, a pipe, a hose or more specifically flexible tubing, transfer tubing, pump tubing, chemical resistant tubing, high purity tubing, smooth bore tubing, fluoroelastomer lined pipe, or rigid pipe, or any combination thereof. In a particular embodiment, the multilayer tube can be used as tubing or hosing where chemical resistance and transparency is desired. For instance, a tubing is a pump tube, such as for liquid dispensing, a peristaltic pump tube, or a liquid transfer tube, such as a chemically resistant liquid transfer tube.

Applications for the tubing are numerous. In an exemplary embodiment, the tubing may be used in applications such a cosmetic product, a beauty product, household wares, industrial, wastewater, digital print equipment, automotive, or other applications where transparency, clarity, chemical resistance, and/or low permeation to gases and hydrocarbons are desired.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A tube includes: a layer including a fluoropolymer having a crystallite size of less than about 380 nanometers per crystalline particle and a refractive index of less than 1.40.

Embodiment 2. A method of forming a tube includes: providing a fluoropolymer; extruding the fluoropolymer at a temperature of greater than 550° F.; and quenching the extruded fluoropolymer at a temperature of less than 80° F.

Embodiment 3. The tube or the method of forming the tube of any of the preceding embodiments, wherein the fluoropolymer includes a homopolymer, copolymer, terpolymer, or polymer blend formed from a monomer comprising tetrafluoroethylene, hexafluoropropylene, chlorotrifluoroethylene, trifluoroethylene, vinylidene fluoride, vinylidene difluoride, vinyl fluoride, perfluoropropyl vinyl ether, perfluoromethyl vinyl ether, or any combination thereof.

Embodiment 4. The tube or the method of forming the tube of embodiment 3, wherein the fluoropolymer includes a terpolymer of tetrafluoroethylene, hexafluoropropylene, and vinylidene difluoride.

Embodiment 5. The tube or the method of forming the tube of any of the preceding embodiments, wherein the fluoropolymer has a crystallinity of greater than 50%, such as greater than 55%, such as greater than 60%, or even greater than 65%.

Embodiment 6. The tube or the method of forming the tube of any of the preceding embodiments, wherein the fluoropolymer has a transparency of greater than about 80%, such as greater than about 85%, such as greater than about 90%, or even greater than about 95%.

Embodiment 7. The tube or the method of forming the tube of any of the preceding embodiments, wherein the tube has an outside diameter within a range of about 0.25 mm to about 10.0 mm, such as a range of about 0.5 mm to about 5.0 mm.

Embodiment 8. The tube or the method of forming the tube of any of the preceding embodiments, wherein the tube has an inner diameter within a range of about 0.1 mm to about 3.0 mm, such as about 0.1 mm to about 2.0 mm, or even about 0.1 mm to about 1.0 mm.

Embodiment 9. The tube or the method of forming the tube of any of the preceding embodiments, wherein the tube is connected to a pump.

Embodiment 10. The tube or the method of forming the tube of any of the preceding embodiments, wherein the tube is immersed into a liquid fragrance.

Embodiment 11. The tube or the method of forming the tube of embodiment 10, wherein the liquid fragrance and the tube each have a refractive index, and a difference between the refractive index of the tube and the liquid fragrance is not greater than about 0.04.

Embodiment 12. The method of forming the tube of embodiment 2, wherein extruding the fluoropolymer includes a line speed of at least 200 fpm (feet per minute), such as at least 225 fpm, such as at least 240 fpm, or even greater than 250 fpm.

Embodiment 13. The method of embodiment 2, wherein extruding the fluoropolymer is at a temperature of 550° F. to 650° F.

Embodiment 14. The method of embodiment 13, wherein extruding the fluoropolymer is at a temperature of 560° F. to 620° F.

Embodiment 15. The method of embodiment 13, wherein extruding the fluoropolymer is at a temperature of 600° F. to 650° F.

Embodiment 16. The method of embodiment 2, wherein quenching the extruded fluoropolymer is at a temperature of 60° F. to 80° F.

Embodiment 17. The method of embodiment 2, wherein the fluoropolymer has a refractive index of less than 1.40, such as less than about 1.38, or even less than about 1.37.

Embodiment 18. The method of embodiment 2, wherein the fluoropolymer has a crystallite size of less than about 380 nanometers per crystalline particle.

Embodiment 19. A tube made by the method of embodiment 2.

Embodiment 20. A tube includes: a layer including a terpolymer of tetrafluoroethylene, hexafluoropropylene, and vinylidene difluoride, wherein the terpolymer has a crystallite size of less than about 380 nanometers per crystalline particle.

Embodiment 21. The tube of embodiment 20, wherein the tube is connected to a pump.

Embodiment 22. The tube of embodiment 20, wherein the tube is immersed into a liquid fragrance.

Embodiment 23. The tube of embodiment 22, wherein the liquid fragrance and the tube each have a refractive index, and a difference between the refractive index of the tube and the liquid fragrance is not greater than about 0.04.

Embodiment 24. The tube of embodiment 20, wherein the terpolymer has a refractive index of less than 1.40, such as less than about 1.38, or even less than about 1.37.

Embodiment 25. The tube of embodiment 20, wherein the terpolymer has a crystallinity of greater than 50%, such as greater than 55%, such as greater than 60%, or even greater than 65%.

Embodiment 26. The tube of embodiment 20, wherein the terpolymer has a transparency of greater than about 80%, such as greater than about 85%, such as greater than about 90%, or even greater than about 95%.

Embodiment 27. The tube of embodiment 20, wherein the tube has an outside diameter within a range of about 0.25 mm to 10.0 mm, such as a range of about 0.5 mm to 5.0 mm.

Embodiment 28. The tube of embodiment 20, wherein the tube has an inner diameter within a range of about 0.1 mm to about 3.0 mm, such as about 0.1 mm to about 2.0 mm, or even about 0.1 mm to about 1.0 mm.

Embodiment 29. A fragrance product includes a container containing liquid fragrance; and a dispenser assembly for dispensing the liquid fragrance including: a transport assembly; and a tube connected to the transport assembly and extending into the liquid fragrance, wherein the tube includes a terpolymer of tetrafluoroethylene, hexafluoropropylene, and vinylidene difluoride, wherein the terpolymer has a crystallite size of less than about 380 nanometers per crystalline particle.

Embodiment 30. The fragrance product of embodiment 29, wherein the liquid fragrance and the tube each have a refractive index, and a difference between the refractive index of the tube and the liquid fragrance is not greater than about 0.04.

Embodiment 31. The fragrance product of embodiment 29, wherein the terpolymer has a refractive index of less than 1.40, such as less than about 1.38, or even less than about 1.37.

Embodiment 32. The fragrance product of embodiment 29, wherein the terpolymer has a crystallinity of greater than 50%, such as greater than 55%, such as greater than 60%, or even greater than 65%.

Embodiment 33. The fragrance product of embodiment 29, wherein the terpolymer has a transparency of greater than about 80%, such as greater than about 85%, such as greater than about 90%, or even greater than about 95%.

Embodiment 34. The fragrance product of embodiment 29, where the tube has an outside diameter within a range of about 0.25 mm to about 10.0 mm, such as a range of about 0.5 mm to about 5.0 mm.

Embodiment 35. The fragrance product of embodiment 29, wherein the tube has an inner diameter within a range of about 0.1 mm to about 3.0 mm, such as about 0.1 mm to about 2.0 mm, or about 0.1 mm to about 1.0 mm.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### Examples

In one example, the terpolymer of tetrafluoroethylene, hexafluoropropylene, and vinylidene difluoride (THV) was extruded under the following conditions: Melt temperature: 590° F. to 610° F., line speed: 230 to 255 fpm, quench tank temperature: 60° F. to 80° F., to form a 1.58 mm OD tube. In another example, the terpolymer of tetrafluoroethylene, hexafluoropropylene, and vinylidene difluoride was extruded under the following conditions: Melt temperature: 620° F. to 640° F., line speed: 270 to 290 fpm, quench tank temperature: 60° F. to 80° F., to form a 1.58 mm OD tube. Further testing revealed that high temperature extrusion in combination with quenching provided high transparency and/or low crystallite particle size, even with crystallinity measured at 68% and 75%. It is contemplated that fine dimensional tubes assisted in achieving a generally uniform temperature profile through the thickness of the tube, further enhancing transparency and/or forming smaller crystallite sizes. It is contemplated that the melt temperature, quenching, or combination thereof provided faster formation of crystallite particles of advantageous size for better clarity compared to a tube processed with low temperature extrusion and no quenching. Comparison tubes of the same material with low temperature extrusion and no quenching of the samples were found to found to be hazy, not achieving high transparency and having low clarity.

Soaking Test:

A tube was made from a terpolymer of tetrafluoroethylene, hexafluoropropylene, and vinylidene difluoride (THV), extruded at a temperature greater than 550° F., quenched at a temp less than 80° F., had a crystallinity content of 57% and a crystallite size of 13 nm was submerged in 100% isopropyl alcohol for eight days. The tubing saw less than 5% dimensional change and no decrease in tensile properties.

Aging Test:

A tube made from THV, extruded at a temperature greater than 550° F., quenched at a temp less than 80° F., with a crystallinity content of 57% and a crystallite size of 13 nm was aged in an oven for 30 days at 50° C. The test simulated 6 months of real time. The tubing saw less than 3% dimensional change and no decrease in tensile properties.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A tube comprises:
a layer comprising a fluoropolymer having a crystallite size of less than about 380 nanometers per crystalline particle and a refractive index of less than 1.40.

2. The tube in accordance with claim 1, wherein the fluoropolymer comprises a homopolymer, copolymer, terpolymer, or polymer blend formed from a monomer comprising tetrafluoroethylene, hexafluoropropylene, chlorotrifluoroethylene, trifluoroethylene, vinylidene fluoride, vinylidene difluoride, vinyl fluoride, perfluoropropyl vinyl ether, perfluoromethyl vinyl ether, or any combination thereof.

3. The tube in accordance with claim 2, wherein the fluoropolymer comprises a terpolymer of tetrafluoroethylene, hexafluoropropylene, and vinylidene difluoride.

4. The tube in accordance with claim 1, wherein the fluoropolymer has a crystallinity of greater than 50%, such as greater than 55%, such as greater than 60%, or even greater than 65%.

5. The tube in accordance with claim 1, wherein the fluoropolymer has a transparency of greater than about 80%, such as greater than about 85%, such as greater than about 90%, or even greater than about 95%.

6. The tube of claim 1, wherein the tube is immersed into a liquid fragrance.

7. A method of forming a tube comprises:
providing a fluoropolymer;
extruding the fluoropolymer at a temperature of greater than 550° F.; and
quenching the extruded fluoropolymer at a temperature of less than 80° F.

8. The method of forming the tube in accordance with claim 7, wherein the fluoropolymer comprises a homopolymer, copolymer, terpolymer, or polymer blend formed from a monomer comprising tetrafluoroethylene, hexafluoropropylene, chlorotrifluoroethylene, trifluoroethylene, vinylidene fluoride, vinylidene difluoride, vinyl fluoride, perfluoropropyl vinyl ether, perfluoromethyl vinyl ether, or any combination thereof.

9. The method of forming the tube in accordance with claim 8, wherein the fluoropolymer comprises a terpolymer of tetrafluoroethylene, hexafluoropropylene, and vinylidene difluoride.

10. The method of forming the tube in accordance with claim 7, wherein the fluoropolymer has a crystallinity of greater than 50%, such as greater than 55%, such as greater than 60%, or even greater than 65%.

11. The method of forming the tube in accordance with claim 7, wherein the fluoropolymer has a transparency of greater than about 80%, such as greater than about 85%, such as greater than about 90%, or even greater than about 95%.

12. The method of forming the tube in accordance with claim 7, wherein extruding the fluoropolymer comprises a line speed of at least 200 fpm (feet per minute), such as at least 225 fpm, such as at least 240 fpm, or even greater than 250 fpm.

13. The method of forming the tube in accordance with claim 7, wherein extruding the fluoropolymer is at a temperature of 550° F. to 650° F.

14. The method of forming the tube in accordance with claim 7, wherein quenching the extruded fluoropolymer is at a temperature of 60° F. to 80° F.

15. The method of forming the tube in accordance with claim 7, wherein the fluoropolymer has a crystallite size of less than about 380 nanometers per crystalline particle.

16. A tube comprises:
a layer comprising a terpolymer of tetrafluoroethylene, hexafluoropropylene, and vinylidene difluoride, wherein the terpolymer has a crystallite size of less than about 380 nanometers per crystalline particle.

17. The tube in accordance with claim 16, wherein the tube is immersed into a liquid fragrance.

18. The tube in accordance with claim 17, wherein the liquid fragrance and the tube each have a refractive index, and a difference between the refractive index of the tube and the liquid fragrance is not greater than about 0.04.

19. The tube in accordance with claim 16, wherein the terpolymer has a crystallinity of greater than 50%, such as greater than 55%, such as greater than 60%, or even greater than 65%.

20. The tube in accordance with claim 16, wherein the terpolymer has a transparency of greater than about 80%, such as greater than about 85%, such as greater than about 90%, or even greater than about 95%.
